(19) United States
(12) Patent Application Publication
(10) Pub. No.: US 2025/0303912 A1
(43) Pub. Date: Oct. 2, 2025

(54) METHOD AND DEVICE FOR VEHICLE CHARGING ACCORDING TO AN ADAPTER SPECIFICATION

(71) Applicant: Dr. Ing. h.c. F. Porsche Aktiengesellschaft, Stuttgart (DE)

(72) Inventors: Adrian UMERLE, Stuttgart (DE); David Dallinger, Konstanz (DE)

(21) Appl. No.: 19/083,483

(22) Filed: Mar. 19, 2025

(30) Foreign Application Priority Data
Mar. 27, 2024 (DE) 10 2024 108 694.7

(51) Int. Cl. B60L 53/66; B60L 53/16; B60L 53/30; B60L 53/65

(52) U.S. Cl. CPC B60L 53/66; B60L 53/16; B60L 53/305; B60L 53/65

(57) ABSTRACT

A method for vehicle charging according to an adapter specification, the method including arranging a charging plug adapter in a transition between a charging plug and a charging connection of a vehicle and storing a profile dependent on at least one transition resistor of the adapter, which has charging current limits as a function of a charging time, in a charging file on a storage medium of a controller of the vehicle along with a specification of the adapter. The method further includes transmitting a code from the plug to the controller via a line between an auxiliary contact of the plug and the vehicle before a charging process to identify the adapter. The method further includes detecting the specification of the adapter with the controller using the code and reading the profile from the file using the detected specification and performing the charging process according to the profile.

### CROSS REFERENCE TO RELATED APPLICATIONS

This application claims benefit to German Patent Application No. DE 10 2024 108 694.7, filed on Mar. 27, 2024, which is hereby incorporated by reference herein.

### FIELD

The present disclosure relates to a method for vehicle charging according to an adapter specification and to a device with which the method is executable.

### BACKGROUND

A DC charging plug according to the North American Charging Standard (NACS) is becoming increasingly popular in the USA for charging electric vehicles at charging stations, so that charging plugs according to the previous Combined Charging System (CCS1) will be replaced. Although an NACS infrastructure will presumably be established in the future, there will still be vehicles with CCS1 charging connections for a transition period of several years, and it should also still be possible to use an already existing CCS1 infrastructure. In addition to the US, charging infrastructures with their own standards are also developing in other regions of the world, especially with regard to charging plugs.

Adapters are therefore available to enable vehicles to charge at a charging column. However, adapters introduce a (further) transition resistance, which leads to heating of components, wherein monitoring the temperature of the adapter is difficult or at least complex. Solutions known from the prior art propose a two-stage shutdown concept, for example, when temperature thresholds are exceeded, wherein a charging current is reduced sharply in a first stage, and a charging interruption then occurs in a second stage.

Publication DE 10 2019 121 108 B3 describes a solution in which a signal line is provided between an adapter element and the charging control unit, which makes it possible to query at least one feature for detection of the adapter. This feature could be a specific resistance, for example. Based on this detected feature, the charging profile can be adapted to the respective plug accordingly.

DE 10 2021 134 295 A1 discloses a charging control unit for an electric vehicle that receives an identification code or location information from a wall adapter. Based on this information, the charging control unit may adjust the charging parameters of the vehicle.

Publication DE 10 2022 202 826 A1 shows an adapter with an integrated coding element, which can be, for example, a resistance. This coding element allows the power system of the vehicle to adjust to the expected power output.

### SUMMARY

In an embodiment, the present disclosure provides a method for vehicle charging according to an adapter specification, the method comprising arranging a charging plug adapter in a transition between a charging plug of a charging column and a charging connection of a vehicle and storing a charging profile which is dependent on at least one transition resistor of the charging plug adapter, which has charging current limits as a function of a charging time, in a charging file on a storage medium of a charging controller of the vehicle along with a specification of the charging plug adapter. The method further comprises transmitting a binary signal code from the charging plug to the charging controller via a line between an auxiliary contact of the charging plug and the vehicle before a start of a charging process in order to identify the charging plug adapter. The method further comprises detecting the specification of the charging plug adapter with the charging controller using the binary signal code and reading the charging profile from the charging file using the detected specification and performing the charging process according to the charging profile.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a circuit diagram of a configuration of a device according to the present disclosure.

### DETAILED DESCRIPTION

Aspects of the present disclosure are directed at providing a method for detecting a charging plug adapter arranged between a charging plug of a charging column and a charging connection of a vehicle. The detection process should not impair interoperability with the charging column. Furthermore, aspects provide a system on which the method can be performed is.

According to an embodiment of the present disclosure, a method for vehicle charging according to an adapter specification is provided, in which a charging plug adapter is arranged in a transition between a charging plug of a charging column and a charging connection of a vehicle. A charging profile which depends at least on a transition resistance of the charging plug adapter, which has charging current limits as a function of a charging time, is stored in a charging file on a storage medium of a charging control unit of the vehicle along with a specification of the charging plug adapter. A binary signal code is transmitted by the charging plug adapter to the charging control unit via a line between an auxiliary contact of the charging plug and the vehicle before the start of a charging process in order to identify the charging plug adapter. The charging control unit uses the binary signal code to recognize the specification of the charging plug adapter and reads the charging profile from the charging file using the detected specification. The charging process is performed according to the charging profile.

With the arrangement of the charging plug adapter in the transition between the charging plug and the charging terminal, a transition resistance is inevitably introduced into a line provided for a charging current. Over the course of charging the vehicle or its traction battery, heat loss occurs at the transition resistance and thus heats up the charging plug adapter, the temperature of which must remain below a specified temperature limit. This specification restricts the flow of current through the charging plug adapter as a function of the (charging) time or the associated heating and defines the charging profile. Such a charging profile defined by the charging plug adapter does not show, for example, any restriction of the charging current for a first period of time, for example five minutes from the start of the charging process. After this first period of time has elapsed, the charging plug adapter has heated up for the first time, whereupon an upper charging current limit is reduced to a first level, for example 90%, of the full charging current. After a second period of time has elapsed, e.g., another five minutes, the charging plug adapter has continued to heat up even with the charging current reduced to the first level, and the upper charging current limit must be reduced to a second level, which is less than the first level and is, e.g., 80% of the full charging current. The charging profile with restrictions on the charging current through upper charging current limits as a function of a charging time results differently depending on the specification of a respective charging plug adapter, for example caused by different transition resistances depending on the choice of a metal alloy in the conductor material of the respective charging plug adapter or upper temperature limits of the components used. Charging plug adapters, which are also designed for fast charging columns with 800V, have different upper charging current limits than charging plug adapters for ordinary charging columns at 400 V.

The signal code for detection or identification of the charging plug adapter is advantageously transmitted before the start of the charging process, i.e., before a switching of a charging current, in order not to impair interoperability between the charging column and the vehicle, in particular its charging control unit. For this purpose, the auxiliary contact on the output side of the charging column is assigned a contact voltage to ground and this contact voltage is modulated according to the binary signal code.

In an embodiment of the method according to the present disclosure, the auxiliary contact is connected to a charging plug contact from the following list: Control Pilot, abbreviated to CP, Proximity Pilot, abbreviated to PP. In general, the auxiliary contact is formed with a contact provided in any charging plug for a control function, which is assigned with the contact voltage (which is low compared to the charging voltage) by the charging column.

In an embodiment of the method according to the present disclosure, a parallel circuit with two branches is arranged by the charging plug adapter in the line between the auxiliary contact of the charging plug and the vehicle. A predetermined resistance is arranged in the first branch and a bypass switch is arranged in the second branch. The binary signal code is formed by the bypass switch modulated with Morse code.

In an embodiment of the method according to the present disclosure, different charging profiles are formed for the charging plug adapter as a function of at least one environmental parameter. Environmental parameters, such as weather conditions, affect heat dissipation from the charging plug adapter. Thus, rain and/or wind can lead to increased heat dissipation, and upper charging current limits can be increased accordingly. Heat dissipation from the charging plug adapter also varies depending on the outside temperature, so that the upper charging current limits in the charging profile are accordingly adjusted downwards as the outside temperature rises.

In an embodiment of the method according to the present disclosure, the transmission of the binary signal code is triggered by at least one trigger from the following list before the start of the charging process: timer after start at charging station, completion of mechanical coupling of charging plug/charging plug adapter/charging connection, detection of voltage signal by charging control unit.

Furthermore, a device for vehicle charging according to an adapter specification is provided, wherein the device comprises a charging plug adapter and a charging control unit arranged in a vehicle with storage medium. A charging profile which depends at least on a transition resistance of the charging plug adapter, which has charging current limits as a function of a charging time, is stored in a charging file on the storage medium of the charging control unit of the vehicle along with a specification of the charging plug adapter. The charging plug adapter is configured to.
be arranged in a transition between a charging plug of a charging column and a charging connection of a vehicle;
transmit a binary signal code to a charging control unit of the vehicle before the start of a charging operation for an identification of the charging plug adapter via a line between an auxiliary contact of the charging plug and the vehicle.

The charging control unit is configured to
recognize the specification of the charging plug adapter using the binary signal code and read the charging profile from the charging file using the detected specification, and
perform the charging process according to the charging profile.

In an embodiment of the charging plug adapter according to the present disclosure, the auxiliary contact is connected to a charging plug contact from the following list: Control Pilot, Proximity Pilot.

In an embodiment of the device according to the present disclosure, the charging plug adapter is configured to arrange a parallel circuit with two branches in the line between the auxiliary contact of the charging plug and the vehicle, wherein a predetermined resistor is arranged in the first branch and a bypass switch is arranged in the second branch, and wherein the bypass switch is configured to modulate the binary signal code using Morse code.

In an embodiment of the device according to the present disclosure, different charging profiles are formed as a function of at least one environmental parameter.

In an embodiment of the device according to the present disclosure, the transmission of the binary signal code is triggered by at least one trigger from the following list before the start of the charging process: timer after start at charging station, completion of mechanical coupling of charging plug/charging plug adapter/charging connection, detection of voltage signal by charging control unit.

Further advantages and embodiments of the present disclosure will emerge from the description and the accompanying drawings.

It is understood that the aforementioned features and the features yet to be explained in the following can be used not only in the respectively specified combination, but also in other combinations or on their own, without leaving the scope of the present disclosure.

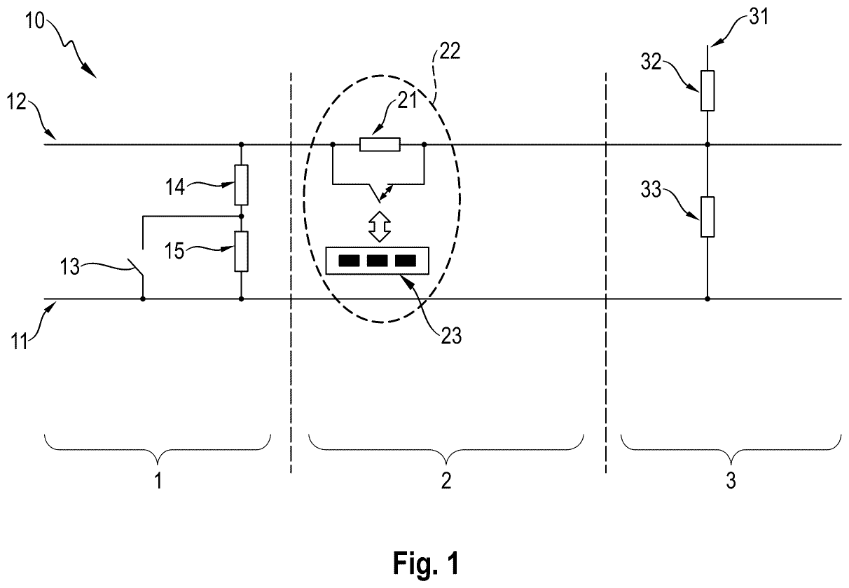

FIG. 1 shows a circuit diagram of a configuration of the device according to an embodiment of the present disclosure.

In FIG. 1, a circuit diagram 10 of a configuration of the device according to the present disclosure is shown. A charging plug adapter 2 is arranged between a charging plug of a charging column 1 and a charging connection of a vehicle 3. The charging plug adapter 2 adapts respective contacts of the charging plug to corresponding contacts of the charging connection, in particular a contact to a ground potential 11 and an auxiliary contact 12, for example a PP contact or a CP contact. A switch 13 and resistors 14, 15 are shown on the charging plug side of the charging column 1, a 5V DC connection 31 and resistors 32, 33 are shown in an exemplary circuit on the charging connection side of the vehicle 3, wherein the first resistor 14 is rated as 150 ohms, the second resistor 15 at 330 ohms, the third resistor 32 at 330 ohms, and the fourth resistor 33 at 2.7 kOhms. The charging plug adapter 2 comprises a parallel circuit 22 with two branches. A predetermined resistance 21 is arranged in the first branch and a bypass switch is arranged in the second branch. According to the present disclosure, the bypass switch forms a binary signal code 23, e.g., as Morse code. Using binary signal code 23, a charging control unit of the vehicle detects a specification of the charging plug adapter 2 and can take a charging profile with upper charging current limits as a function of a charging time from an associated file and design a charging of a traction battery of the vehicle accordingly.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for vehicle charging according to an adapter specification, the method comprising:
arranging a charging plug adapter in a transition between a charging plug of a charging column and a charging connection of a vehicle;
storing a charging profile which is dependent on at least one transition resistor of the charging plug adapter, which has charging current limits as a function of a charging time, in a charging file on a storage medium of a charging controller of the vehicle along with a specification of the charging plug adapter;
transmitting a binary signal code from the charging plug to the charging controller via a line between an auxiliary contact of the charging plug and the vehicle before a start of a charging process in order to identify the charging plug adapter;
detecting the specification of the charging plug adapter with the charging controller using the binary signal code and reading the charging profile from the charging file using the detected specification; and
performing the charging process according to the charging profile.

2. The method according to claim 1, further comprising connecting the auxiliary contact to a charging plug contact from the following list: control pilot and proximity pilot.

3. The method according to claim 1, further comprising:
arranging a parallel circuit with two branches by the charging plug adapter in the line between the auxiliary contact of the charging plug and the vehicle;
arranging a predetermined resistor in a first branch of the two branches and arranging a bypass switch in a second branch of the two branches; and
forming the binary signal code with the bypass switch modulated with Morse code.

4. The method according to claim 1, further comprising forming different charging profiles for the charging plug adapter as a function of at least one environmental parameter.

5. The method according to claim 1, further comprising triggering transmission of the binary signal code with at least one trigger from the following list of triggers before the start of the charging process: a timer after start at the charging station, a completion of a mechanical coupling of the charging plug, the charging plug adapter, or the charging connection, and a detection of voltage signal by the charging controller.

6. A device for vehicle charging according to an adapter specification, the device comprising:
a charging plug adapter; and
a charging controller with a storage medium arranged in a vehicle,
wherein a charging profile which is dependent on at least one transition resistor of the charging plug adapter, which has charging current limits as a function of a charging time, is stored on the charging controller storage medium in a charging file along with a specification of the charging plug adapter,
wherein the charging plug adapter is configured to:
be arranged in a transition between a charging plug of a charging column and a charging connection of the vehicle, and
transmit a binary signal code to the charging controller of the vehicle before a start of a charging process for an identification of the charging plug adapter via a line between an auxiliary contact of the charging plug and the vehicle, and
wherein the charging controller is configured to:
recognize the specification of the charging plug adapter using the binary signal code and read the charging profile from the charging file using the detected specification, and
perform the charging process according to the charging profile.

7. The device according to claim 6, wherein the auxiliary contact is connected to a charging plug contact from the following list: Control Pilot and Proximity Pilot.

8. The device according to claim 6, wherein the charging plug adapter is configured to arrange a parallel circuit with two branches in the line between the auxiliary contact of the charging plug and the vehicle,
wherein a predetermined resistor is arranged in a first branch of the two branches and a bypass switch is arranged in a second branch of the two branches, and
wherein the bypass switch is configured to modulate the binary signal code by Morse code.

9. The device according to claim 6, wherein different charging profiles are formed as a function of at least one environmental parameter.

10. The device according to claim 6, wherein transmission of the binary signal code is triggered by at least one trigger from the following list of triggers before the start of the charging process: a timer after start at the charging station, a completion of mechanical coupling of the charging plug, a charging plug adapter, or a charging connection, and a detection of a voltage signal by the charging controller.
